(19) United States
(12) Patent Application Publication
(10) Pub. No.: US 2010/0064118 A1
(43) Pub. Date: Mar. 11, 2010

(54) Method and Apparatus for Reducing Latency Associated with Executing Multiple Instruction Groups

(75) Inventor: Charles H. Moore, Sierra City, CA (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/208,152

(22) Filed: Sep. 10, 2008

(51) Int. Cl. G06F 9/30

(52) U.S. Cl. 712/206; 712/E09.016; 712/221

(57) ABSTRACT

A method and apparatus for reducing latency in computer processors. The method incorporates a special instruction set that provides an indication of whether a particular instruction is capable of being executed nearly simultaneously with a preceding instruction in the same group. In such a situation, multiple instructions may be executed at a rate faster than expected. A simple apparatus for accomplishing this method is illustrated.

### BACKGROUND OF THE INVENTION

1. Field of Invention

The invention is related to data processing—particularly to methods and apparatus for reducing the latency associated with executing multiple instruction groups.

2. Description of the Background Art

Data processing includes the sending of a series of instructions to a central processing unit (CPU). The series of instructions are in turn collected into instruction groups. The instruction group(s) may include either instructions such as +, −, * /, and/or fetch, etc., or data such as a sting of numbers. In machine language there is typically an instruction set of all the instructions a processor will accept. These instructions are loaded into registers which are a form of short term memory. As would be expected, there is a time delay between asking for an instruction and the execution of the instruction. A measure of this time delay is called “latency”.

The term latency can have many different meanings, depending on the application. Latency is the time delay between the moment something is initiated and the moment one of its effects begins or becomes detectable. For example, assume an event a, at a time ta and event b, at some time later at time tb. This relationship implies tb>ta>0 and for this example assume that event b is a direct result of event a. In this particular example, the latency would be defined as time tb−ta. Understanding latency from this example means the effects of event a are potential, not immediate, or are not yet observable until time tb.

Latency is an important concept when many actions are associated with a certain event. Suppose that a person who owns a ten-room home has hired a maid to clean the house. This maid will only be able to complete one room at a time. In this particular example, assume it takes the maid time ti to clean the ith room of the home. Therefore if the person who owns a ten-room home has only hired one maid then the latency, L, for the house cleaning is as follows:

$$L = {\sum }_{i = 1}^{10} {t}_{i} , \qquad ( 1 )$$

the sum of the time it takes the maid to clean all ten rooms. Suppose instead that two maids have been hired. Maid one is responsible for cleaning rooms 1-5 and maid two is responsible for cleaning rooms 6-10. In this case it is possible for each maid to be cleaning a room at a time. However, because the time for cleaning each room has not been well defined, it cannot be stated which maid will finish the task of cleaning first. Unfortunately, the winner of this so-called cleaning contest does not account for the latency; instead it is the slower of the two which contributes to the latency.

$$L = max ( {\sum }_{i = 1}^{5} {t}_{i} , {\sum }_{i = 6}^{10} {t}_{i} ) , \qquad ( 2 )$$

If three maids were hired to clean the same home, the latency would simply be the time that it takes the slowest maid to clean her portion of the house. These examples (when more than one maid is utilized to clean the home) assume that once a maid has finished with their portion of the work, they do not help the other maid(s) complete their work. This means that only one maid can clean one room at a time. In the more general case when an event is associated with j actions, the latency associated with the event is the time it takes for the j actions to be completed. Latency is improved when those j actions can be completed in parallel (at the same time as another action(s)). Additionally, the j actions are bound below in the sense that the smallest latency is the time it takes to complete the slowest j action. Thus latency is formally defined next:

max(j)≦L≦Σj, (3)

where the latency is at most the time which is required to execute all of the j events (this is the worst or slowest case) and the latency is at best the time which is required to execute the most time consuming jth event (this is the best or fastest case).

### SUMMARY OF THE INVENTION

The invention provides a method and apparatus for expedited execution of instructions to provide a dramatic reduction of latency. This in turn can result in a speed of execution of instruction which is far greater than would be expected by the clock speed of a given processor.

The invention allows the processor to “look ahead” at incoming data to determine if it is an instruction applicable to the process. If the instruction is such an instruction, it is loaded virtually simultaneously with the preceding instruction. This is accomplished without supplementary caching as conventionally used in so-called prefetch operations and processes.

### BRIEF DESCRIPTION OF THE DRAWINGS

FIG. 1 depicts a flow diagram describing the instruction group execution;

FIG. 2 illustrates the instruction group register;

FIG. 3 is a flow diagram detailing an element from FIG. 1;

FIG. 4 shows a timing diagram representing two blocks from the flow diagram illustrated in FIG. 1;

FIG. 5 depicts a flow diagram showing the method in which fetching of the next instruction group is accomplished;

FIG. 6 is a logic circuit depicting a specific instruction groups sent from FIG. 5; and

FIG. 7 is a timing diagram representing the fetching of the next instruction group during the execution of the slot 3 instruction of the instruction group.

### DETAILED DESCRIPTION OF THE DRAWINGS

The invention is illustrated with a processor using an 18-bit bus and 18-bit instruction groups. Each instruction group can be divided into slots. Each slot corresponds to an instruction. Executing instructions in a sequential manner is the case with conventional processors when no new instruction can begin until the old instruction has finished. In the case of executing the four slots of the 18-bit instruction group, the execution of the fetching of the next instruction group will always occur after, and never before or during the four instruction slot executions. Therefore, the latency of the time needed to execute all of the slots of the current instruction and fetching of the next instruction group is the addition of the time needed to complete each of the two tasks separately. In the case where these two tasks could be accomplished in parallel, then it is possible to reduce the latency of this process up to the time it takes to complete the slowest task. The invention is illustrated using an 18-bit multicore processor.

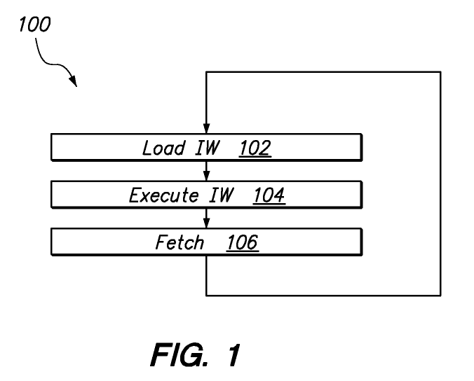

The conventional method of instruction execution in a sequential manner can be found in the flow chart of FIG. 1. A method 100 is shown which describes the actions associated with executing an instruction group and acquiring the next instruction group for execution. While this method begins with step 102, it could just as easily begin at either step 104 or step 106. It is assumed that by beginning with any element in the method 100 there is an instruction group available for loading, executing or fetching. However, for simplicity the method is shown to begin at step 102. Step 102 defines the action of loading the current instruction group which will be executed as defined by step 104. Step 106, which completes the method 100, defines the action of fetching the next instruction group. Following the actions associated with step 106 is a return to step 102, the beginning of method 100. The method continues until there are no instructions left to execute.

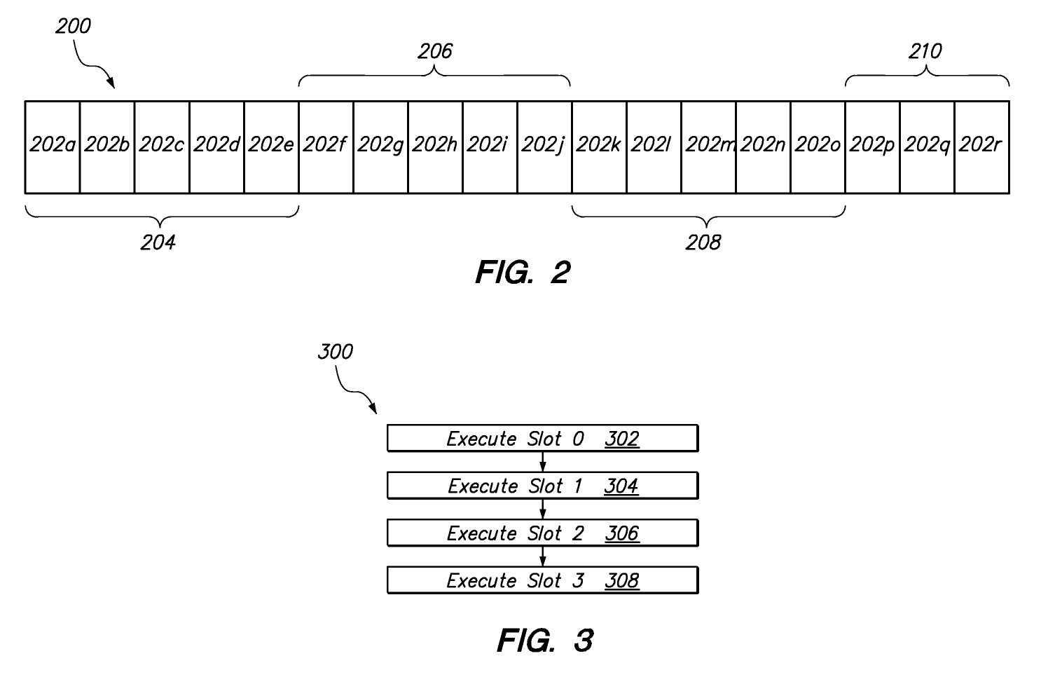

FIG. 2 illustrates a single layer of an instruction group register as used in SEAforth® 24 and 40 multicore processors designed by IntellaSys® of Cupertino, Calif. SEAforth® is a registered trademark of IntellaSys®. These processors use 18-bit data lines, also called single drop buses between the cores. Instruction group register 200 is designed to contain instruction groups for execution as described in FIG. 1. In this embodiment, instruction group register 200 is shown containing 18 bits labeled 202a-202r. Since register 200 is a part of a binary computer, each of the bits 202 will be a ‘1’ or a ‘0’. Additionally, the 18-bit instruction group register is grouped into four slots. Slot 0, labeled as 204, is made up of five bits, bits shown as 202a-202e. Slot 1, labeled as 206, is made up of five bits, bits shown as 202f-202j. Slot 2, labeled as 208, is made up of five bits, bits shown as 202k-202o. Slot 3, labeled as 210, is made up of three bits, bits shown as 202p-202r. The bit lengths of the four slots are not equal as the division of 18 by 4 results in a remainder and for this reason the designers of the SEAforth® 24 and 40 consider an instruction group to contain 3 and ⅗ instructions, as each instruction is five bits wide. The VentureForth® instruction set is the instructions which control execution of the SEAforth® 24 and 40. The instruction set is made up of 32 operational codes (“op-codes”), each of which are 5 bits wide, thus making what would appear to be a slot in which no op-code can fit. However, the designers of the VentureForth® instruction set only utilize slot 3 for certain op-codes. It should be noted that the instruction group register 200 can actually contain instructions, data, or some combination thereof. The 18-bit instruction group register 200 is always read as a whole and therefore, since there is always a potential of having up to four instructions in the instruction group register 200, a no operation (“no-op”) instruction is included in the VentureForth® instruction set to provide for instances when using all of the available slots contained in instruction group register 200 might be unnecessary or even undesirable. In the event of their being an instruction in slot 3, a virtual slot 4 is used to allow loading of the next instruction. Virtual slot 4 is hardwired to have a no-op instruction.

The method 300 shown in FIG. 3 is a detailed description of step 104, the execution of the instruction group in FIG. 1. This method has four steps and must strictly begin at step 302, the execution of the instruction in slot 0. This is followed by step 304, the execution of the instruction in slot 1. The third step of this method, step 306, is the execution of the instruction in slot 2. The last action associated with this method is step 308, the execution of the instruction in slot 3. Note that when this method 300 is combined with method 100 of FIG. 1 in the sense that the four steps of method 300 replace step 104 from FIG. 1, this indicates the sequential execution of the four instructions contained in the instruction group followed by the execution of the fetching of the next instruction. In the event of their being an instruction in slot 3, a virtual slot 4 is used to allow loading of the next instruction. Virtual slot 4 is hardwired to have a no-op instruction.

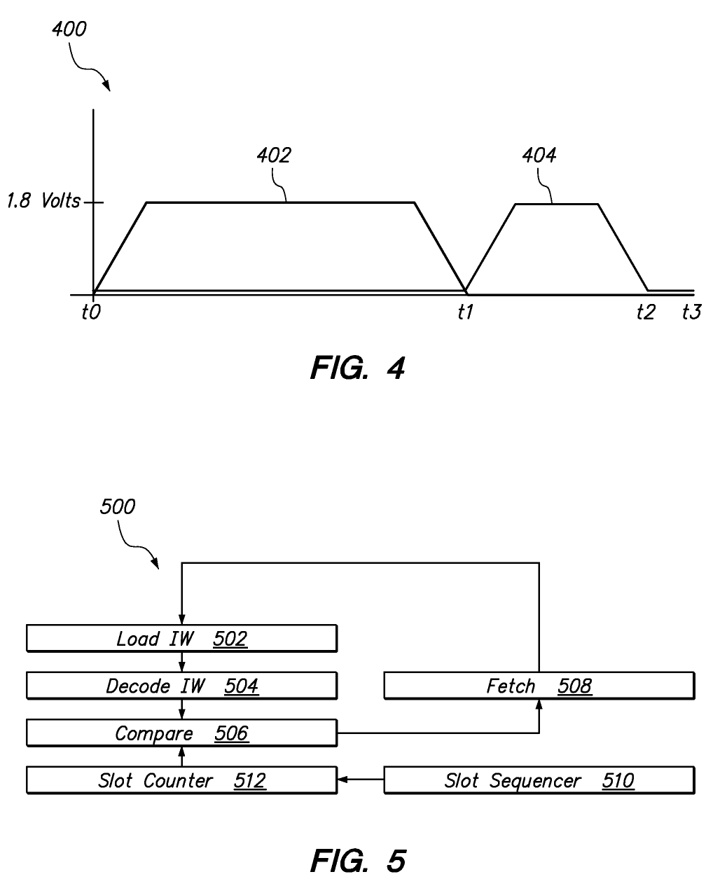

FIG. 4 shows a timing diagram representing element 104 and element 106 from the flow diagram illustrated in FIG. 1. Plot 400 shows two curves denoted as curve 402 and curve 404. Both curves begin at time t₀ and end at time t₃. However, only one curve is non-zero for a particular geometric region. Specifically, curve 402 is non-zero from time t₀ to time t₁ and this curve is representative of element 104 of FIG. 1. More specifically, this curve encompasses all the actions associated with method 300 of FIG. 3, the execution of all four slots of the instruction group. Curve 404 is non-zero from time t₁ to time t₂ and this curve represents the action associated with element 106 of FIG. 1, the fetching of the next instruction group from memory. This timing diagram is representative of the sequential action of executing the entire instruction group followed by fetching the next instruction group for execution.

FIG. 5 illustrates a flow diagram depicting the inventive method for performing the fetching of the next instruction group such that the latency L, for the process of executing the instruction group and the fetching of the next instruction group is reduced. The method 500 described herein begins with step 502, the loading of the instruction group. The method 500 could also begin with step 508 in another embodiment of the method for performing the fetching of the next instruction group. Regardless of whether the method is shown to begin at element 502 or 508, there must be an instruction group available for loading or fetching to begin at either step in the flow diagram. The fact that this method could begin at step 508 instead of step 502 does not add to the explanation of the inventive method, and for this reason it will not be discussed in any great detail as an alternative embodiment.

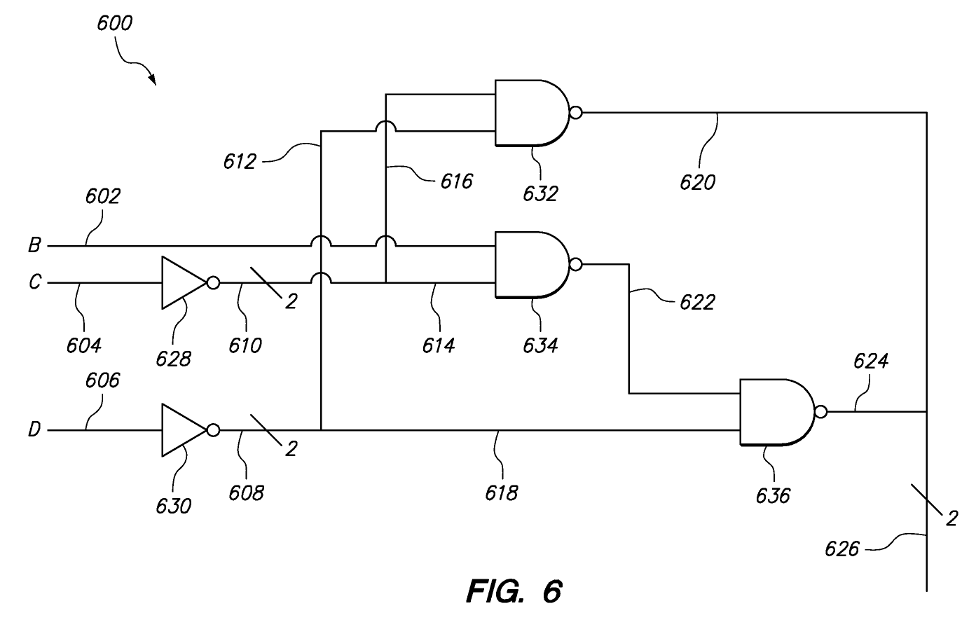

Method 500 begins with element 502, the loading of the instruction group which is a similar beginning to that of method 100 of FIG. 1. The next executable block in the flow diagram is step 504, the decoding of the instruction group. This decode is described in more detail in FIG. 6. The result of decoding the instruction group is a 2 bit value which is utilized as the first of two inputs to the next block of the flow diagram step 506, the comparison block.

A slot sequencer 510 is in charge of incrementing the slot counter defined by step 512. Slot counter 512 provides the second input to compare step 506. A shift register is one easy component to use for slot counter 512, as it need not be 3 bits wide as a conventional counter, which must identify all 5 potential slots. The second input is a 2 bit binary value ranging from binary ‘00’ to ‘11’ to which the decimal equivalent is 0 to 3. Compare step 506 is thus a comparison for equality between slot counter 512 and the value produced from decoding step 504 of the instruction group. Once equality has been reached, the fetching 508 of the next instruction group begins. Thus, prior to the execution of slot 0 of the current instruction group, slot sequencer 510 has made slot counter 512 contain a value of 0. After execution of slot 0 and before the execution of slot 0 of the instruction group, slot sequencer 510 will increment slot counter 512 to the value of 1. Thus, the value contained by slot counter 512 can be thought of as incrementing at the end of the slot. After execution of the second slot of the instruction group (slot 1) slot sequencer 510 will increment slot counter 512 to a value of 2. The execution of slot 2 of the instruction group will result in an increment of slot counter 512 to a value of 3. Finally, the execution of the instruction contained in the last slot of the instruction group (slot 3) results in slot sequencer 510 reducing slot counter 512 to the value of 0, not an increment to the value of 5. This is done so that the execution of the next instruction group can be accomplished utilizing the same decimal 0 to 3 to represent the appropriate slot. Slot sequencer 510 can be thought of as providing the value to slot counter 512 as some counter value which begins at zero, is indefinitely incremented, and modulus 4. Method 500 does not depict instruction group execution in the same manner that method 100 does. In fact, method 500 does not make any reference to instruction group execution. Instead, method 500 only makes reference to when the fetching of the next instruction group will take place with respect to the slot in which the instruction group register is about to execute. That is once slot counter 512 and the decode values are equal the fetching 508 of the next instruction will take place. Due to the fact that the incrementing of slot counter 510 is directly associated with the execution of each slot within the instruction group, there is no need to directly reference instruction slot execution in the flow diagram describing method 500. This is contrasted to the prior art where the fetching of the next instruction group will only occur after all slots of the instruction group are executed. Method 500 is a method for performing the fetching of the next instruction group before all slots of the current instruction group are executed.

FIG. 6 illustrates a logic circuit which accomplishes the decoding of the instruction, step 504, as shown in FIG. 5. The purpose of this decode is to produce a 2 bit value which is utilized in the compare block 506 along with the value from the slot counter block 512 to determine the fetching of the next instruction group with respect to instruction slot execution. In actual use equivalent firmware or software may be used as a substitute for this circuit. There are three inputs to the decode logic circuit 600 shown in FIG. 6; labeled B, C, and D. Input B produces a single logic value along wire 602, while inputs C and D produce two logic values each along wires 604 and 606, respectively. The logic value produced along wire 602 is the first of two inputs to the NAND logic gate 634. The second input to gate 634 is produced via one of the logic values along wire 604 from input C. Before one of the logic values of wire 604 reaches gate 634, the value must first pass through logic gate 628, which inverts the value producing a new value along wire 610 (two total values along wire 610). Due to the fact that input C produces two logic values, wire 610 can logically split these two values along wires 614 and 616. Wire 614 provides the second input to the logic NAND 634, whose output is a single logic bit along wire 622. Wire 616 is the first of two inputs to logic NAND gate 632 where the second input is provided via input D to the decode logic circuit 600. Input D produces two logic values, similarly to input C, along wire 606. These two logic values are inverted via logic gate 630, producing two equivalent new values along wire 608. These two equivalent logic values are then split such that wire 612 contains one of the logic values which is the second input to the logic NAND gate 632, whose output is a single logic bit along wire 620. The split of wire 608 results in the second value along wire 618, which is one of two inputs to logic NAND gate 636. The second input to logic gate 636 is provided from wire 622, which is the output from the logic gate 634. Logic NAND gate 636 produces a single logic valued output along wire 624. The output from logic NAND gate 632 along wire 620 is joined with wire 624, producing a two valued logic value along wire 626. Therefore, the logic value along wire 626 can be any of the four possible binary configurations ‘00’, ‘01’, ‘10’, and ‘11’ (0 to 3 decimal) where the first value of the two logic values comes from wire 620 and the second comes from wire 624.

The description of FIG. 6 above does not specifically state where the inputs for B, C, and D stem from. FIGS. 2 and 3 show the division of the instruction group into four unequal slot lengths in terms of the number of bits needed to represent those slot lengths. Inputs B, C, and D are produced by using the high order bit or most left bit in slot 1, 2, and 3 respectively of the current instruction group. The ability to only utilize three bits out of 18 of the current instruction group to determine the fetching of the next instruction group is a consequence of the design of the 32 op-codes. In SEAforth® 24 and 40 processors, the high order or most left bit in the instructions differentiates the instruction from being either an arithmetic logic unit (“ALU”) instruction or a memory instruction. Since the high order or most left bit of three of the four slots of the instruction group is sufficient for determining the fetching of the next instruction, this has greatly reduced the complexity of the logic circuit associated with the decoding of the instruction group block, element 504 of FIG. 5. Recall that the fetching of the next instruction group, element 508 of FIG. 5 is only referenced with respect to the instruction slot that is being executed within the instruction group. The high order or most left bit of slots 1, 2, and 3 are utilized as inputs B, C, and D in logic circuit 600. Noticeably missing in logic circuit 600 is the use of the high order or most left bit of slot 0. The use of this bit would significantly complicate the logic circuit used to represent the decoding of the instruction block element 504 of FIG. 5. For this reason, the logic circuit has been left out, as it does not add to the explanation of using one bit per instruction within the instruction group for determining the fetching of the next instruction group. In other implementations of this method, logic circuit 600 is replaced with a circuit that includes the use of the highest order or most left bit of the slot 0 instruction contained in the instruction group to allow the fetching of the next instruction group to begin as early as slot 0.

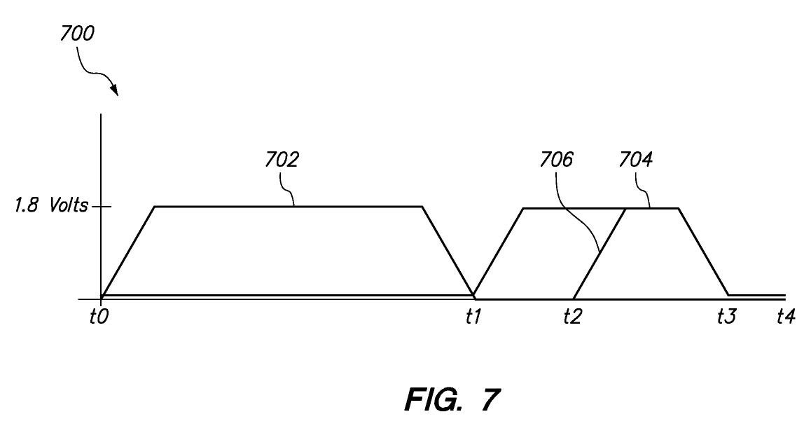

FIG. 7 is a timing diagram representing the fetching of the next instruction group during the execution of the slot 3 instruction of the instruction group. Shown in plot 700 are three curves 702, 704, and 706 in which they all begin at time t₀ and end at time t₄. Unlike the background art plot 400, there is more than one curve which is non-zero at a time; however this is the novelty, as will be explained. Curve 702 represents the execution of slots 0, 1, and 2 of the instruction group which references the execution of the instruction slots referenced in FIG. 3 of the background art and this curve is shown as non-zero from time t₀ to time t₁. Curve 704 represents the execution of the instruction contained in slot 3 of the instruction group which begins at time t₁ and does not end until time t₃. During this time, the fetching of the next instruction group takes place beginning with time t₂ and ending with time t₃. Notice that instead of fetching the next instruction after the four instructions contained by the instruction group are executed, as is the case in the background art of plot 400, the fetching of the next instruction is completed concurrently with the execution of the instruction slot 3 of the instruction group. In other terms, the curves are non-zero in the same geometric region. The fetching of the next instruction group and execution of the instruction in slot 3 are completed in such a way that the completion of the execution of the instruction in slot 3 coincides with the completion of the fetching of the next instruction. Thus, the latency associated with executing four instructions contained by an instruction group and the fetching of the next instruction has been reduced. This is due to the fact that the latency associated with executing the instructions contained in slots 0, 1, and 2 are exactly the same as in the background art. The difference is that now instead of the latency associated with executing the instruction in slot four and the fetching of the next instruction being the sum of the time required to complete those two actions separately, the latency is the time it takes to complete the slower of the two actions which is shown to be the execution of the instruction in slot 3. It is important to note that while plot 700 shows each curve being non-zero, for some geometric regions this geometric region is arbitrary in that the time in which each curve is non-zero is not the important feature of this plot. Instead, the most important fact is the relationship between the two curves which are non-zero in the same geometric region. Finally, it is important to point out that two additional timing diagrams could be shown at this point. The first of the two timing diagrams would refer to the concurrent action of the fetching of the next instruction and the execution of two instructions, the instructions found in slots 2 and 3. The fetching of the next instruction group would begin very close to the beginning of the execution of the slot 2 instruction. The fetching would end with the end of the execution of the slot 3 instruction. The second of the two timing diagrams would display the fetching of the next instruction group and the execution of three instructions, the instructions found in slots 1, 2, and 3. The fetching would begin close to the start of the execution of the instruction in slot 1 and end with the end of the instruction execution of slot 3. These two timing diagrams have not been shown as figures, as they would not add to the novelty of the invention and have therefore been omitted; however an important consequence of beginning the fetching of the next instruction as early as slot 2 or slot 1 reduces the latency time associated with execution of all the instructions contained within an instruction group and the fetching of the next instruction group.

While various embodiments have been described above, it should be understood that they have been presented by way of example only, and the breadth and scope of the invention should not be limited by any of the above described exemplary embodiments, but should instead be defined only in accordance with the following claims and their equivalents.

### INDUSTRIAL APPLICABILITY

The inventive computer registers 200 logic array 600, instruction set and method are intended to be widely used in a great variety of computer applications. It is expected that they will be particularly useful in applications where significant computing power and speed is required.

As discussed previously herein, the applicability of the present invention is such that the inputting information and instructions are greatly enhanced, both in speed and versatility. Also, communications between a computer array and other devices are enhanced according to the described method and means. Since the inventive computer registers 200 logic array 600, and the method of the present invention may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

I claim:

1. A system for reducing latency in a computer processor executing a stream of instruction by reducing latency associated with waiting for fetching of instructions until a prior instruction is executed comprising: an instruction set including a plurality of memory instructions and a plurality of arithmetic logic unit instructions wherein the arithmetic logic unit instructions are distinguishable from the memory instructions; and a comparator in said computer processor for distinguishing arithmetic logic unit instructions from memory instructions; and wherein said comparator fetches arithmetic logic unit instructions substantially coincident with the execution of a prior arithmetic logic unit instruction to reduce latency associated with waiting for fetching of instructions until a prior instruction is executed.

2. A system for reducing latency in a computer processor executing a stream of instruction by reducing latency associated with waiting for fetching of instructions until a prior instruction is executed, as in claim 1, wherein one bit of each instruction indicates whether the instruction is an arithmetic logic unit instruction.

3. A system for reducing latency in a computer processor executing a stream of instruction by reducing latency associated with waiting for fetching of instructions until a prior instruction is executed as in claim 2, wherein one bit is the highest order bit of the arithmetic logic unit instruction.

4. A system for reducing latency in a computer processor executing a stream of instruction by reducing latency associated with waiting for fetching of instructions until a prior instruction is executed as in claim 1, wherein said comparator detects the highest order bit of an instruction to determine if said instruction is an arithmetic logic unit instruction.

5. A system for reducing latency in a computer processor executing a stream of instruction by reducing latency associated with waiting for fetching of instructions until a prior instruction is executed as in claim 1, wherein said comparator is comprised of a logic array selected from the group of hard wired logic arrays, firmware equivalents of logic arrays and software equivalents of logic arrays.

6. A system for reducing latency in a computer processor executing a stream of instruction by reducing latency associated with waiting for fetching of instructions until a prior instruction is executed as in claim 1, wherein said comparator detects the highest order data bit in an instruction and fetches the instruction if it is an arithmetic logic unit instruction substantially coincident with execution of the prior arithmetic logic unit instruction.

7. A system for reducing latency in a computer processor executing a stream of instruction by reducing latency associated with waiting for fetching of instructions until a prior instruction is executed as in claim 1, further comprising a slot counter connected to said comparator for providing an input to compare with an incoming instruction.

8. A system for reducing latency in a computer processor executing a stream of instruction by reducing latency associated with waiting for fetching of instructions until a prior instruction is executed as in claim 7, wherein said slot counter is a shift register.

9. A system for reducing latency in a computer processor executing a stream of instruction by reducing latency associated with waiting for fetching of instructions until a prior instruction is executed as in claim 8, further comprising a decoder connected to said comparator for decoding incoming instructions.

10. A method for reducing latency in computer processing of a stream of incoming information groups having a plurality of instructions comprising the steps of loading an incoming information group and determining if the loaded instruction group contains any arithmetic logic instructions, and fetching the next incoming information group substantially coincident with the execution of the arithmetic logic instruction, and determining if the next loaded instruction group contains and continuing the process until all instructions are loaded and executed.

11. A method for reducing latency in computer processing of a stream of incoming information groups having a plurality of instructions as in claim 10, further comprising the step of decoding the loaded information group.

12. A method for reducing latency in computer processing of a stream of incoming information groups having a plurality of instructions as in claim 10, wherein said determining step is accomplished by comparing the instructions in said loaded information group to a count of slots in said information group.

13. A method for reducing latency in computer processing of a stream of incoming information groups having a plurality of instructions as in claim 12 wherein said counting is aided by a step of sequencing the slots.

14. A method for reducing latency in computer processing of a stream of incoming information groups having a plurality of instructions as in claim 10, wherein said determining step is performed by examining the highest order bit of each incoming instruction.

15. A computer processor for loading and executing a stream of incoming information groups comprising a loader for loading incoming information groups into a register; and a comparator for determining if an incoming instruction is an arithmetic logic instruction and immediately fetching the next instruction if the previous instruction was an arithmetic logic instruction.

16. A computer processor as in claim 15, further comprising a decoder for decoding loaded instruction groups.

17. A computer processor as in claim 15, further comprising a slot counter connected to said comparator for providing an input to compare with an incoming instruction.

18. A computer processor as in claim 17, further comprising a slot sequencer connected to said slot counter for incrementing said slot counter.

19. A computer processor as in claim 17, wherein said slot counter is a shift register.

20. A computer processor as in claim 15, wherein said comparator detects the highest order data bit in an instruction and fetches the instruction if it is an arithmetic logic unit instruction substantially coincident with execution of the prior arithmetic logic unit instruction.

21. A computer processor as in claim 15, wherein said comparator is comprised of a logic array selected from the group of hard wired logic arrays, firmware equivalents of logic arrays and software equivalents of logic arrays.

22. A computer processor as in claim 20, wherein said group receives information regarding the highest order bit in each slot of each information group to determine if each slot is filled with an arithmetic logic unit instruction.
